(19) United States
(12) Patent Application Publication
(10) Pub. No.: US 2023/0385857 A1
(43) Pub. Date: Nov. 30, 2023

(54) PREDICTIVE SYSTEMS AND PROCESSES FOR PRODUCT ATTRIBUTE RESEARCH AND DEVELOPMENT

(71) Applicant: Simporter, Inc., Atlanta, GA (US)

(72) Inventors: Dillon Hall, Atlanta, GA (US); Igor Andreev, Atlanta, GA (US)

(21) Appl. No.: 18/345,615

(22) Filed: Jun. 30, 2023

Related U.S. Application Data
(63) Continuation of application No. 18/318,428, filed on May 16, 2023.
(60) Provisional application No. 63/342,932, filed on May 17, 2022.

(51) Int. Cl. G06Q 30/0202; G06N 5/022

(52) U.S. Cl. CPC G06Q 30/0202; G06N 5/022

(57) ABSTRACT

The systems and methods described herein can include a data store and at least one computing device in communication with the data store. The at least one computing device is configured to receive historical data for a plurality of historical products in a plurality of markets, train a predictive model to forecast at least one product performance attribute based on the historical data, receive product data associated with a particular product, generate a prediction for the particular product of the at least one product performance attribute by applying the predictive model, and perform at least one action for the particular product based on the prediction of the at least one product performance attribute.

### CROSS-REFERENCE TO RELATED APPLICATIONS

This application is a continuation application of U.S. patent application Ser. No. 18/318,428, filed May 16, 2023 and entitled “PREDICTIVE SYSTEMS AND PROCESSES FOR PRODUCT ATTRIBUTE RESEARCH AND DEVELOPMENT” which claims the benefit of and priority to, U.S. Provisional Patent Application No. 63/342,932, filed May 17, 2022 and entitled “PREDICTIVE SYSTEMS AND PROCESSES FOR PRODUCT ATTRIBUTE RESEARCH AND DEVELOPMENT,” the entire contents and substance of which are incorporated herein by reference in their entireties.

### TECHNICAL FIELD

The present systems and processes relate generally to product performance prediction and optimization.

### BACKGROUND

Being able to predict, analyze, and comprehend the myriad of factors that affect the sales performance of an item can have a drastic impact on a business. This is especially true for items that haven't been released yet or are recently released. Unfortunately, there are no current systems and methods that are capable of aggregating information regarding a particular item and generate a multitude of predictions associated with the sales performance of the particular item. Additionally, there are no known techniques for aggregating information on other items that have known sales histories and using this information to generate sales predictions and other predictions for a distinct item. Therefore, there exists an unresolved need for systems and methods that are capable of extracting information regarding various items, generating models associated with the various items to predict one or more factors, and applying the models to new unreleased or recently released items to determine predictions of the one or more factors specific to the unreleased or recently released items.

### BRIEF SUMMARY OF THE DISCLOSURE

Briefly described, and according to one embodiment, aspects of the present disclosure generally relate to systems and processes for predicting the performance of various products and product attributes. In various embodiments, the present systems and processes generate performance analysis and predictions for guiding and optimizing product development. According to one embodiment, based on analyses of historical product and sales data, the present systems and processes generate sales and other performance predictions for product that are absent a sales history or for which there exists limited sales history (e.g., due to the product not having yet entered the market or only recently entering the market). In various embodiments, the present systems and processes can forecast the sales performance of a new, current, or planned product by evaluating the product's attributes and identifying how those attributes may influence product performance (e.g., based on intelligence regarding historical performance of other products that may or may not demonstrate the same attribute(s)).

In various embodiments, the present systems and processes can analyze historical product data, performance, and attributes and generate predictions for the performance of new products and/or product attributes. In at least one embodiment, the systems and processes utilize natural language processing, machine learning, and artificial intelligence, or combinations thereof, to analyze historical data for sales performance, market sentiment, and product attributes. In one or more embodiments, the systems and processes leverage the analyses to generate predictions for a) product sales volume (e.g., at a particular price level, via a particular channel, at a particular location, over a particular time interval, with particular product attributes, or combinations thereof), b) the impact of price and other attribute changes on sales volume, and c) generating recommendations for product development strategy to propel product performance.

In one or more embodiments, the present systems and processes identify psychographic data from customer reviews via one or more natural language processing (NLP) techniques and trained machine learning models. In various embodiments, the disclosed prediction system generates an aggregated psychographic database with selectable filters of consumer personas, interests, and lifestyles. According to one embodiment, the prediction system provides access to the psychographic database via a web application that graphically displays psychographic data over selected periods and within product categories. In at least one embodiment, the prediction system extracts psychographic information from product reviews. In one or more embodiments, the prediction system uses probabilistic classifiers, and/or other suitable techniques, to classify the psychographic information into one or more categories and generate one or more training datasets based on the classifications. In various embodiments, the prediction system generates, trains, and executes models for automatically identifying the most probable psychographic of a review based off of the language used in an analyzed review. In one or more embodiments, the prediction system generates predictions for identifying different types of consumer behavior based on analyses of psychographic information.

In at least one embodiment, the systems and process may manually or automatically calculate success drivers for improving brand health and reach (e.g., important brand topics, product attributes, econometric indicators, psychographic indicators, etc.). In various embodiments, the systems and processes predict sales data for products using unstructured data, such as search, customer reviews, and social media data. In one or more embodiments, the disclosed prediction system extracts potential success drivers and their sentiment from unstructured text data and determines an importance score for each brand, each product, or each product attribute. In at least one embodiment, the prediction system determines one or more most important success drivers, generates a graphical report including the most important success drivers, and displays the graphical report at a networking address accessible via a web application.

According to one embodiment, the disclosed systems and processes automatically identifying a product's characteristics from product-related media, such as a product description, product advertisement, or product-related writings (e.g., meeting notes, executive summaries, electronic communications, etc.). In at least one embodiment, the systems and processes predict sales data for new or planned products based on econometric data associated with the product or historical econometric data associated with similar products. In one or more embodiments, the systems and processes enable prediction of competition and/or consumer demand at product or product attribute levels.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment.

FIG. 1 shows an example networked environment in which the present prediction system may operate, according to one embodiment of the present disclosure.

FIG. 2 shows an example prediction process, according to one embodiment of the present disclosure.

FIG. 3 shows an example data preparation process, according to one embodiment of the present disclosure.

FIG. 4 shows an prediction process, according to one embodiment of the present disclosure.

FIG. 5 shows an example prediction summary, according to one embodiment of the present disclosure.

FIG. 6 shows an example data prediction process, according to one embodiment of the present disclosure.

FIG. 7 shows an example data prediction process, according to one embodiment of the present disclosure.

### DETAILED DESCRIPTION

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for predicting the performance of various products and product attributes. In various embodiments, the present systems and processes generate performance analysis and predictions for guiding and optimizing product development. According to one embodiment, based on analyses of historical product and sales data, the present systems and processes generate sales and other performance predictions for products that are absent a sales history or for which there exists limited sales history (e.g., due to the product not having yet entered the market or only recently entering the market). In various embodiments, the present systems and processes can forecast the sales performance of a new, current, or planned product by evaluating the product's attributes and identifying how those attributes may influence product performance (e.g., based on intelligence regarding historical performance of other products that may or may not demonstrate the same attribute(s)).

In various embodiments, the present systems and processes can analyze historical product data, performance, and attributes and generate predictions for the performance of new products and/or product attributes. In at least one embodiment, the systems and processes utilize natural language processing, machine learning, and artificial intelligence, or combinations thereof, to analyze historical data for sales performance, market sentiment, and product attributes. In one or more embodiments, the systems and processes leverage the analyses to generate predictions for a) product sales volume (e.g., at a particular price level, via a particular channel, at a particular location, over a particular time interval, with particular product attributes, or combinations thereof), b) the impact of price and other attribute changes on sales volume, and c) generating recommendations for product development strategy to propel product performance.

In one or more embodiments, the present systems and processes identify psychographic data from customer reviews via one or more natural language processing (NLP) techniques and trained machine learning models. In various embodiments, the disclosed prediction system generates an aggregated psychographic database with selectable filters of consumer personas, interests, and lifestyles. According to one embodiment, the prediction system provides access to the psychographic database via a web application that graphically displays psychographic data over selected periods and within product categories. In at least one embodiment, the prediction system extracts psychographic information from product reviews. In one or more embodiments, the prediction system uses probabilistic classifiers, and/or other suitable techniques, to classify the psychographic information into one or more categories and generate one or more training datasets based on the classifications. In various embodiments, the prediction system generates, trains, and executes models for automatically identifying the most probable psychographic of a review based off of the language used in an analyzed review. In one or more embodiments, the prediction system generates predictions for identifying different types of consumer behavior based on analyses of psychographic information.

In at least one embodiment, the systems and process may manually or automatically calculate success drivers for improving brand health and reach (e.g., important brand topics, product attributes, econometric indicators, psychographic indicators, etc.). In various embodiments, the systems and processes predict sales data for products using unstructured data, such as search, customer reviews, and social media data. In one or more embodiments, the disclosed prediction system extracts potential success drivers and their sentiment from unstructured text data and determines an importance score for each brand, each product, or each product attribute. In at least one embodiment, the prediction system determines one or more most important success drivers, generates a graphical report including the most important success drivers, and displays the graphical report at a networking address accessible via a web application.

According to one embodiment, the disclosed systems and processes automatically identifying a product's characteristics from product-related media, such as a product description, product advertisement, or product-related writings (e.g., meeting notes, executive summaries, electronic communications, etc.). In at least one embodiment, the systems and processes predict sales data for new or planned products based on econometric data associated with the product or historical econometric data associated with similar products. In one or more embodiments, the systems and processes enable prediction of competition and/or consumer demand at product or product attribute levels.

### Exemplary Embodiments

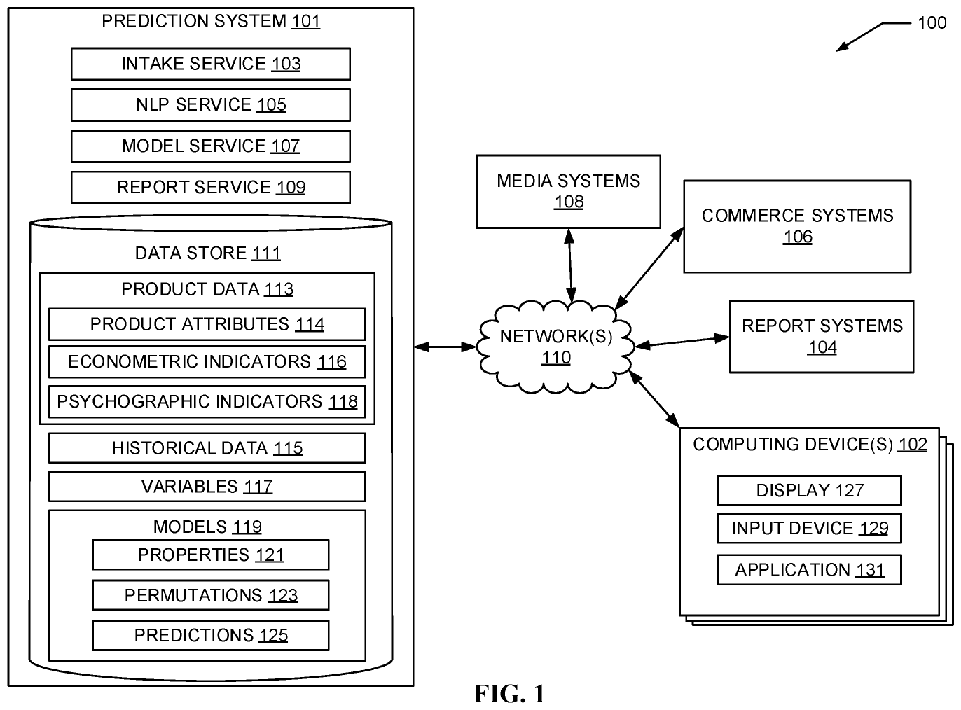

Referring now to the figures, for the purposes of example and explanation of the fundamental processes and components of the disclosed systems and processes, reference is made to FIG. 1, which illustrates an example networked environment 100. As will be understood and appreciated, the networked environment 100 shown in FIG. 1 represents merely one approach or embodiment of the present concept, and other aspects are used according to various embodiments of the present concept.

The networked environment 100 can include, but is not limited to, the prediction system 101, one or more computing devices 102, one or more report systems 104, one or more commerce systems 106, and one or more media systems 108. The prediction system 101 can communicate with the computing device 102, report system 104, commerce system 106, and media system 108 via one or more networks 110. The network 110 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks. In at least one embodiment, the prediction system 101 accesses one or more application programming interfaces (API) to facilitate communication and interaction between the prediction system 101 and the computing device 102, report system 104, commerce system 106, and/or media system 108.

The report system 104 can include any platform, website, database, system, or other computing environment that generates, stores, or is otherwise capable of providing product-related reports. Non-limiting examples of product-related reports include consumer reviews, professional reviews, product-rating charts and scorecards, and product rankings. Non-limiting examples of report systems 104 include product sale websites, retail websites, and consumer review databases.

The commerce system 106 can include any platform, website, database, system, or other computing environment that generates, stores, or is otherwise capable of providing product-related sales data. Non-limiting examples of product-related sales data include sale volumes, sale revenue, cost of sale, product profitability, product purchase transactions, product refunds, product exchanges, and financial data related to providing particular product attributes or engaging particular econometric or psychographic indicators. Non-limiting examples of commerce systems 106 include merchant sale systems, banking systems, personal finance tracking systems, financial report platforms, and point of sale (PoS) databases.

The media system 108 can include any platform, website, database, system, or other computing environment that generates, stores, or is otherwise capable of providing product-related media data. Non-limiting examples of media data include social media posts, influencer and product critic reports (e.g., in written, audio, video, or multimedia format), user interaction and sentiment data (e.g., cookie data, audience engagement and impact data, social media post ratings, likes, and dislikes, and viewership data, etc.). Non-limiting examples of media systems 108 include social media platforms, video hosting and sharing platforms, and written or digital publication platforms.

The prediction system 101 can include, but is not limited to, an intake service 103, natural language processing (NLP) service 105, model service 107, report service 109, and one or more data stores 111. The elements of the prediction system 101 can be provided via a plurality of computing devices that may be arranged, for example, in one or more server banks or computer banks or other arrangements. Such computing devices can be located in a single installation or may be distributed among many different geographical locations. For example, the prediction system 101 can include a plurality of computing devices that together may include a hosted computing resource, a grid computing resource, and/or any other distributed computing arrangement. In some embodiments, the prediction system 101 can correspond to an elastic computing resource where the allotted capacity of processing, network, storage, or other computing-related resources may vary over time. In one or more embodiments, the prediction system 101 corresponds to a software application or in-browser program that may be accessed via a computing device.

The data store 111 stores various types of information that is used by the prediction system 101 to execute various processes and functions discussed herein. The data store 111 can be representative of a plurality of data stores as can be appreciated. The data store 111 can include, but is not limited to, product data 113, historical data 115, variables 117, and models 119.

Product data 113 can include any data or metadata related to a product. A product can include any good or service, such as, for example, clothes, electronics, pet care, personal banking, childcare, tools, games, furniture, and consumables. Product data 113 can include materials and files related to a product, such as, for example, product advertisements, product descriptions, product images, product videos, and product manuals. Product data 113 can include product attributes 114, such as, for example, a product name, product categories and subcategories, and product launch plans (e.g., the planned time period of launching the product, inventory at launch, etc.). A product attribute 114 can include any characteristic that distinguishes a product. The product attribute 114 can include, for example, product categories, product subcategories, weight, size, flavor, color, claims of benefit, ingredients, licenses, brand, affiliates (e.g., affiliate products and services, personal endorsements or spokespersons, franchise affiliations, etc.), or place of origin. Additional examples of product attributes 114 include metrics shown in Table 1. According to one embodiment, the metrics of Table 1 are indexed on a 1-100 scale in which 100 indicates a “Very High” level or prevalence of the corresponding data element and 0 indicates a “Very Low” level or prevalence of the corresponding data element.

TABLE 1
Exemplary Product Attribute Metrics

| Product | |
|---|---|
| Attribute | |
| Metrics | Description |
| Passion | Captures the level of positive/negative sentiment behind |
| Score | consumer reviews and conversations about an attribute. The |
| | prediction system may utilize passion score to identify product |
| | attributes that are true purchase motivators (e.g., instead of |
| | being solely a “nice to have” product attribute). |
| Demand | Predicts consumer intent for an attribute based on the growth |
| Score | of consumer interest so the prediction system may identify |
| | trends that are most relevant to particular consumer groups. |
| Demand | The average of the demand score prediction over a particular |
| Average | interval (e.g., past 6 months, past year, past 3 weeks, or any |
| | suitable interval). To the prediction system, the demand |
| | average may provide intelligence as to avoiding entering a |
| | product trend too early or too late. |
| Demand | The growth of the demand score prediction over a particular |
| Growth | interval (e.g., past 6 months, past year, past 3 weeks, or any |
| | suitable interval). To the prediction system, the demand |
| | growth may indicate if a product attribute trend or other fad is |
| | increasing, stable, or decreasing. |
| Compe- | How often an attribute appears in product descriptions, on |
| tition | average, over a particular interval (e.g., past 6 months, past |
| Average | year, past 3 weeks, or any suitable interval). To the prediction |
| | system, the competition average may indicate whether a |
| | product attribute is rare (e.g., true white space), common, |
| | semi-common, or oversaturated amongst one or more |
| | channels or consumer groups. |
| Compe- | The growth rate of how often an attribute appears in product |
| tition | descriptions over a particular interval (e.g., past 6 months, |
| Growth | past year, past 3 weeks, or any suitable interval). To the |
| | prediction system, the competition growth may indicate |
| | whether a product seller may be a first mover, rapid follower, |
| | or late bloomer for a particular product or product attribute. |
| Total | Weighted or unweighted blend of demand, competition, and |
| Score | passion score metrics into one actionable score. To the |
| | prediction system, the total score may indicate how a product |
| | or product attribute is predicted to perform overall (e.g., |
| | thereby allowing the prediction system to predict and report |
| | highest value product attributes and/or highest value product |
| | development and sale opportunities). |

The product data 113 can include econometric indicators 116, including, but not limited to, price point(s) of a product, product cost, product distribution levels, product volume (e.g., a desired volume, breakeven volume, minimum volume, etc.), product channel and/or location (e.g., virtual and physical sale locations), mean price, retail sell-through price, distribution of existing products employed at the intended product level, and macroeconomic indicators (e.g., unemployment rate, gross domestic product (GDP), and population growth associated with a particular entity or region). The product data 113 can be associated with a particular interval, such as a weekly, daily, hourly, quarterly, or annual basis.

The product data 113 can include psychographic indicators 118 received from one or more databases, from user inputs, or extracted from reviews and social media data using feature extraction and/or username analysis. The system can identify and extract psychographic indicators by performing natural language processing (NLP), feature extraction, and username analysis of social media data. In one example, the NLP service 105 analyses a username “PatentMan95” and predicts that the username is associated with a user born in 1995. The NLP service 105 can generate additional psychographic indicators of “Age, 26,” “Interest: Patents,” and “Gender: Male.” Non-limiting examples of psychographic indicators 118 include age range, parental status (e.g., parent, grandparent, step-parent, single parent, foster parent, adoptive parent, etc.), gender, sex, marital status, pet status (e.g., dog owner, cat owner, etc.), interests (e.g., athlete, gamer, hobbyist, crafter, foodie, do-it-your-self, etc.), social media activity level, and online reach or influence level.

Product data 113 and historical data 115 can include values for various macroeconomic indicators and search trends (e.g., values being sampled on a weekly, monthly, daily, or any suitable basis). The macroeconomic indicators and search trend values can be stored in association with additional product data 113 or historical data 115, such as data points associated with a time period, channel, or location corresponding to the data value. The intake service 103 can expand the amount of data gathered around each product attribute 114 (e.g., or other element of product data 113 or historical data 115) by capturing additional information, such as search data around the product attribute or the volume and sentiment of reviews and social media data related to the product attribute. The intake service 103 can further enrich a product attribute 114 by obtaining (e.g., via generation, retrieval, or receipt) and storing, in association with the product attribute 114, one or more performance metrics, such as one or more metrics listed in Table 1. According to one embodiment, by generating associations between product attributes 114 and additional data, the intake service 103 generates a structured form of previously unstructured data.

In various embodiments, macroeconomic data includes one or more structured dataset (e.g., quantitative metrics over time). In various embodiments, macroeconomic data improves model performance for predicting changes in price elasticity based on unemployment rate, gross domestic product (GDP), GPD growth, population growth, and other macroeconomic factors. In various embodiments, macroeconomic data may demonstrate predictive power for forecasting the growth potential of product sales based on their price point. For example, unemployment growth often increases sales in certain areas like luxury lipsticks or non-premium toothpaste. In this example, macroeconomic data for unemployment may be used as an input to the present prediction processes and, thereby, capture and leverage the relationship of unemployment and product performance.

Historical data 115 can include any historical product data (e.g., historical product attributes, econometric indicators, and psychographic indicators), historical product sales data, and historical product performance data (e.g., derived from historical product sales data and/or other sources, such as historical reviews, historical accolades, etc.). Non-limiting examples of product performance data include unit and/or revenue sales. The unit and/or revenue sales can be organized by product, by product category and/or subcategory, by time period (e.g., daily, weekly, quarterly, or any suitable period), by channel (e.g., physical retailer, virtual retailer, shopping aggregation services, digital platform, social media account, etc.), by location (e.g., particular address, neighborhood, city, region, state, country, etc.), or combinations thereof. Product categories can include any classification of products, such as, for example, sporting goods, furniture, men's shoes, children's books, hair products, makeup, do-it-yourself projects, and camping gear. In various embodiments, the historical data 115 includes a time-series format such that the model service 107 may input the historical data 115 into model training processes, identify correlations between the historical data 115 and historical sales, and generate predictive forecasting variables 117 that may materially improve prediction accuracy.

The variables 117 include data and metadata in one or more formats suitable for analysis via the models 119. The variables 117 include outputs of processing operations performed on product data 113 and/or historical data 115. The variables 117 can include, for example, encoded and/or multi-dimensional representations of product categories, binary product features, product data features (e.g., from product launch dates and release periods), and encoded representations of additional data, such as macroeconomic indicators, search trend data, data extracted or generated from product comments and reviews, etc.). Non-limiting examples of data features include season or quarter number(s) (e.g., 1, 2, 3, 4), month numbers (e.g., 1, 2, 3 . . . , 12), week numbers (e.g., 1, 2, 3 . . . , 52), number of weeks since product launch (e.g., 0, 1, 2, 3, etc.), holiday calendars, government or other entity-mandated lockdown calendars, and policy occurrences (e.g., inter-state conflicts, legislation passage, legislation expiration or removal, elections, economic regulations and sanctions, etc.).

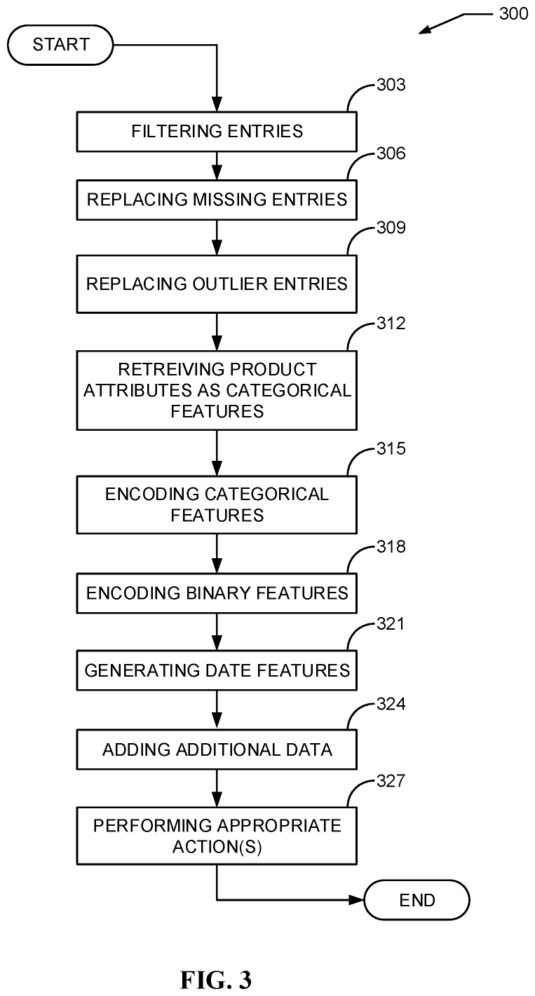

The variables 117 can be arranged into one or more datasets (e.g., training datasets and validation datasets for which performance outcomes are known and experimental, or “live,” datasets for which performance outcomes are unknown). In some embodiments, the properties 121 of one or more models 119 include one or more variables 117. For example, a training dataset stored in properties 121 includes variables 117 that were generated via processing historical data 115 according to the data preparation process 300 shown in FIG. 3 and described herein.

The model 119 can include machine learning models, artificial intelligence models, and other predictive models that can be trained to learn underlying patterns of product data 113 or historical data 115. For example, the model service 107 can train the model 119 to recognize relationships historical product attributes and historical sales performance and volume. Non-limiting examples of models 119 include neural networks, linear regression, logistic regression, ordinary least squares regression, stepwise regression, multivariate adaptive regression splines, ridge regression, least-angle regression, locally estimated scatterplot smoothing, decision trees, random forest classification, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, elastic net, feature selection, computer vision, dimensionality reduction algorithms, and gradient boosting algorithms and modeling techniques (e.g., light gradient boosting modeling, XGBoost modeling, etc.). Neural networks can include, but are not limited to, uni- or multilayer perceptron, convolutional neural networks, recurrent neural networks, long short-term memory networks, auto-encoders, deep Boltzman machines, deep belief networks, back-propagations, stochastic gradient descents, Hopfield networks, and radial basis function networks. The model 119 can be representative of a plurality of models 119 of varying or similar composition or function. For example, the data store 111 includes a plurality of model iterations of varying composition, the plurality of model iterations for generating predictions 125 associated with a particular combination of historical product attributes, econometric indicators, and psychographic indicators (e.g., a permutation 123, as described herein).

The models 119 can include, but are not limited to, properties 121, permutations 123, and predictions 125. The properties 121 can include any parameter, hyperparameter, configuration, or setting of the model 119. Non-limiting examples of properties 121 include coefficients or weights of linear and logistic regression models, weights and biases of neural network-type models, number of estimators, cluster centroids in clustering-type models, train-test split ratio, learning rate (e.g. gradient descent), maximum depth, number of leaves, column sample by tree, choice of optimization algorithm or other boosting technique (e.g., gradient descent, gradient boosting, stochastic gradient descent, Adam optimizer, etc.), choice of activation function in a neural network layer (e.g. Sigmoid, ReLU, Tanh, etc.), choice of cost or loss function, number of hidden layers in a neural network, number of activation units in each layer of a neural network, drop-out rate in a neural network (e.g., dropout probability), number of iterations (epochs) in training a neural network, number of clusters in a clustering task, Kernel or filter size in convolutional layers, pooling size, and batch size. The properties 121 can include training, validation, and testing datasets for training the models 119. A training set can include, but is not limited to, historical product data and product performance data from historical data 115. The properties 121 can include thresholds for evaluating model performance, such as, for example, accuracy thresholds, precision thresholds, deviation thresholds, and error thresholds. In one example, the properties 121 include a threshold accuracy score between 0-1.0.

The permutations 123 can include combinations of product data 113 or historical data 115, or variables 117 derived therefrom. The permutations 123 can include logical operators for combining or controlling the analysis of permutation data elements via the model 119. Non-limiting examples of logical operators include “AND,” “OR,” and “NOT.” In one example, product data 113 for a smart speaker product includes “channels: online site-only, physical retailer, drop-shipping, virtual retailer,” “colors: brown, gray, black,” “weights: 1.0 kg, 2.0 kg, 2.5 kg,” and “features: waterproof, rechargeable, plug-in only, smart assistant-supported.” In this example, example permutations 123 for predicting sales performance of the smart speaker product includes “permutation 1: channels(online site-only), color(gray), weight(1.0 kg), features(waterproof AND rechargeable),” “permutation 2: channels(virtual retailer AND physical retailer), color(black OR gray), features(smart-assistant compatible NOT waterproof), weight(2.5 kg),” and “permutation 3: channels(physical retailer OR drop-shipping OR virtual retailer), color(brown), features(plug-in only), weight (2.0 kg).” The permutations 123 can include any number of elements (e.g., 1, 5, 10, 1000, 1 million, etc.).

The predictions 125 can include outputs of the models 119. Example predictions 125 include, but are not limited to, unit sale estimates, revenue sale estimates, sale estimates by channel, most predictive product data (e.g., attributes and indicators that are most positively or negatively predictive for positive or negative sales performance), relationships between historical product data and historical product performance, optimal product launch dates and release periods, optimal product prices, optimal product inventory volume, estimated consumer demand for product attributes, and estimated competition for products or product attributes.

The intake service 103 can receive data and requests related to functions of the prediction system 101. For example, the intake service 103 receives requests to generate product predictions from one or more computing devices 102. The intake service 103 can receive product data 113 and historical data 115 from the computing device 102, report systems 104, commerce systems 106, and media systems 108. For example, the intake service 103 receives a product description from a computing device 102, the product description including a plurality of product attributes for a particular product. In another example, the intake service 103 receives historical product sales data from the commerce system 106. In another example, the intake service 103 receives customer product reviews and product-related social media comments from a report system 104 and a media system 108.

The intake service 103 can generate product data 113 and historical data 115. The intake service 103 can perform data processing actions including, but not limited to, generating statistical metrics from data (e.g., standard deviation, quantiles, etc), imputing, replacing, and removing data values (e.g., outlier values, null values, missing values, etc.), filtering data values, generating data values (e.g., based on product data 113 or historical data 115), encoding data from a first representation to a second representation, generating categorical features and data features, and other metadata, enriching product data (e.g., by associating product data with other product data and/or metadata, such as time, identification, and location information), generating multi-dimensional data representations, organizing data into one or more datasets (e.g., training datasets, testing datasets, validation datasets, experimental datasets, etc.), and segregating datasets into additional datasets.

The intake service 103 can generate categorical features and data features via one or more analysis techniques, operations, algorithms, or models described herein. The intake service 103 can generate categorical features according to a first technique referred to as “base category features” in which categorical features are derived from historical Point of Sale (PoS) data. The intake service 103 can analyze PoS data and identify product descriptions including product attributes 114, such as, for example, flavor, ingredients, or product form. The intake service 103 can extrapolate key features from syndicated sales data, such as, for example, shelf price, % All Commodity Volume (“ACV”) Distribution, brand name, packaging type, mass, and volume. The intake service 103 (e.g., alone or in combination with the model service 107) can generate categorical features according to a second technique that includes one or more models 119, such as, for example, supervised feature extraction models. The intake service 103 can analyze a product description, product name, product-related social media post, product review, and/or other product-related media via one or more models 119 to identify or generate categorical features including, but not limited to, consumer needs, benefits, ingredients, flavors, textures, sustainability claims, dietary preferences, and forms. The intake service 103 can perform one or more clustering techniques (e.g., k nearest neighbor, mean-shift, Density-Based Spatial Clustering of Applications with Noise (DBSCAN), Expectation-Maximization Clustering using Gaussian Mixture Models (EMGMM), agglomerative hierarchical clustering, etc.) to cluster data elements associated with a particular product attribute 114 into a new product attribute 114 (e.g., also referred to as an “attribute feature” of the particular product attribute 114).

The NLP service 105 can analyze historical data 115 including historical program, data, product data 113, resource data, models 119, various recommendations, and/or computing device inputs to support various processes and functions of the prediction system 101. The NLP service 105 can generate product attributes 114 and psychographic indicators 118 by processing and analyzing other product data 113, such as, for example, social media posts, product descriptions, product advertisements, customer reviews, news articles, product-related images and videos (e.g., advertisements, reaction and review videos, news programs, etc.) and other sources of natural language. In one or more embodiments, the NLP service 105 performs feature extraction on reviews, social media data, and other language sources by performing feature extraction and/or username analysis. Table 2 shows example extracted features and corresponding psychographic indicators that may be generated by the NLP service 105.

TABLE 2
Exemplary Extracted Features and Psychographic Indicators

| Text Sample | Psychographic Indicator |
|---|---|
| “I got this for my kids when . . . ” | Parent |
| “My husband loves to use this for . . . ” | Married |
| “This is the cat's favorite thing . . . ” | Cat Owner |
| “Perfect right before a workout . . . ” | Athlete |

The NLP service 105 can generate product data 113 and historical data 115 based on analyses of electronic records, inputs, and/or metadata associated therewith, from the computing device 102, report system 104, commerce system 106, or media system 108. Non-limiting examples of electronic records include scans of financial transaction records, accounting and inventory records, delivery and distribution records, handwritten documents (e.g., meeting summaries, program notes, etc.), electronic communications (e.g., email conversations, text messages, audio communications, or transcriptions thereof, etc.), product records (e.g., statements of work, work logs, contracts, agreements, invoices, reports, estimates, requests for proposals, proposals, recommendations, policies, protocols, manuals, permits, program assumptions, selection sheets, checklists, advertisements, applications, etc.), and digital media (e.g., photographs or videos, presentation recordings, etc.).

To generate product data 113, historical data 115, or metadata associated therewith, the NLP service 105 can identify, extract, and classify language content via any suitable algorithm, technique, or combinations thereof. In some embodiments, the NLP service 105 communicates with the model service 107 to process data via one or more models 119, such as, for example, machine learning or artificial intelligence models. Non-limiting examples of machine learning and/or artificial intelligence techniques include artificial neural networks, mutual information classification models, random forest or tree models, supervised or unsupervised topic-modeling models, Apriori algorithm-based models, and Markov decision models. In one example, the NLP service 105 receives a set of social media product reviews for processing. The NLP service 105 can analyze the product reviews via a trained neural network that extracts keywords therefrom and store the keywords as product attributes 114. In the same example, the NLP service 105 generates historical data 115 by estimating and storing a level of positive or negative consumer sentiment for the products associated with the product reviews.

The NLP service 105 can perform binary or fuzzy keyword and key phrase matching. The NLP service 105 can determine that an electronic record includes one or more words or phrases from a predetermined keyword list and/or that are included in one or more language libraries or corpuses. The NLP service 105 can perform approximate or fuzzy keyword and key phrase detection, for example, by applying one or more rules, policies, or heuristics. The NLP service 105 can translate electronic records, or portions thereof, into fixed-size vector representations. The NLP service 105 can compare vector representations of electronic records to determine (mis)matches between language from which the representations were derived. The NLP service 105 can perform vector comparisons via any suitable technique or similarity metric, including, but not limited to, Euclidean distance, squared Euclidean distance, Hamming distance, Minkowski distance, L² norm metric, cosine metric, Jaccard distance, edit distance, Mahalanobis distance, vector quantization (VQ), Gaussian mixture model (GMM), hidden Markov model (HMM), Kullback-Leibler divergence, mutual information and entropy score, Pearson correlation distance, Spearman correlation distance, or Kendall correlation distance.

The model service 107 can generate and execute models 119 to predict future sales data for goods, such as, for example, consumer packaged goods (CPGs). The model service 107 can perform one or more cross-validation techniques to verify the stability of the model 119. Non-limiting examples of cross-validation techniques include leave p out cross-validation, leave one out cross-validation, holdout cross-validation, repeated random subsampling validation, k-fold cross-validation, stratified k-fold cross-validation, time Series cross-validation, and nested cross-validation.

In one example, the model service 107 generates a model 119 for predicting the sales volume of a particular product. The model service 107 can train the model 119 using a first training dataset, a second training dataset, and a validating training dataset derived from a set of historical data 115 that is associated with products having similar attributes (e.g., the historical data including sales data, relevant econometric and/or psychographic indicators, and unstructured data, such as social media postings, customer reviews, and search data). The first training dataset can correspond to a first percentage of the set of historical data (e.g., 50%, 60%, 70%, or any suitable value), the second training dataset can correspond to a second percentage of the set of historical data (e.g., 5%, 10%, 15%, or any suitable value), and the validation dataset van correspond to a third percentage of the set of historical data (e.g., 5%, 10%, 15%, or any suitable value).

The model service 107 can evaluate model performance by a) executing the model 119 on training data to generate experimental output, and b) determining model performance metrics by comparing the experimental output to known outcomes associated with the training data. The model service 107 can modify the model towards improving model accuracy until an optimal model 119 is generated (e.g., the optimal model 119 meeting a predetermined accuracy and/or other performance threshold). The model service 107 can execute the optimal model 119 on various permutations 123 of product attributes, econometric indicators, and/or psychographic indicators to generate a plurality of product performance predictions. The model service 107 can identify an optimal permutation by determining the permutation 123 predicted to demonstrate the highest product performance (e.g., as measured in sales volume, revenue, demand, or any suitable performance metric).

The model service 107 can evaluate the performance of the model 119 by generating and analyzing one or more performance metrics including, but not limited to, accuracy, precision, deviation, and error metrics. Non-limiting examples of performance metrics include mean squared error (MSE), root mean squared error (RMSE), and R². The model service 107 can generate an accuracy metric according to Equation 1. The model service 107 can generate a deviation metric according to Equation 2. The model service 107 can determine if the model 119 is of sufficient quality by comparing performance metrics to stored threshold values corresponding to the type of metric. The model service 107 can evaluate the model 119 on a time-dependent frequency, such as weekly, monthly, yearly, or any suitable interval. The model service 107 can retrain and/or adjust the model 119 in response to determining that the performance of the model 119 has degraded in quality and/or is over-fit or under-fit to corresponding product data 113 or historical data 115 (e.g., based on one or more performance metrics failing to meet a threshold value).

$$Accuracy = 1 - \frac{\vert {Sales}_{fact} - {Sales}_{predicted} \vert}{{Sales}_{fact}} \qquad ( Equation 1 )$$

$$Deviation = avg ( \frac{{Sales}_{fact} - {Sales}_{predicted}}{{Sales}_{fact}} ) \qquad ( Equation 2 )$$

The model service 107 can generate and evaluate deviation metrics to determine if the model 119 is under-predictive or over-predictive for one or more types of predictions 125, such as, for example, sales volume, sale trend, and consumer demand. According to one embodiment, the model service 107 generates models 119 such that the models 119 a) account for and evaluate any combination of attributes within a category (e.g., any number of permutations 123), b) generate a prediction 125 on-request or automatically in a virtually instantaneous manner (e.g., as opposed to previous prediction approaches that may require a user to wait weeks or months to develop a product performance forecast). In one or more embodiments, the prediction system 101 captures and updates product data 113 and historical data 115 such that the model service 107 may reuse the categorical features and other information therein to scalably predict sales of new products across one or more product categories. In one or more embodiments, different product categories may include different categorical features and different products within a product category may share a predefined set of features in addition to one or more product-specific features. Toothpaste has its own features different from mouthwash—but to predict two different toothpastes in the United States, one can use the same model built on the same set of categorical features.

The report service 109 can transmit predictions 125 and related information to the computing device 102. For example, the report service 109 generates an electronic communication including a predicted sales volume for a particular product, an indication of the particular product, and one or more most positively or negatively predictive attributes of the particular product. The report service 109 can transmit the electronic communication to a computing device 102 from which an original prediction request was received. The report service 109 can generate and transmit electronic communications in any suitable format or combination of formats including, but not limited to, electronic mail, web- and/or application-hosted media, digital media (e.g., images, videos, multimedia, interactive digital media etc.), charts and other graphical reports, text messages, push alerts, and notifications. The report service 109 can generate data visualizations for visually communicating a prediction 125 and/or other insights related to a product, such as highly weighted variables 117, product-analogous historical data 115 (e.g., historical consumer demand and other product-related trends and benchmarks). The report service 109 can generate user interfaces for communicating predictions 125, for receiving prediction requests from one or more computing devices 102, and/or for modifying one or more aspects of the present prediction process. The report service 109 can host user interfaces and other communications at a networking address and can transmit the networking address to one or more computing devices 102. The report service 109 can cause an application or browser service on the computing device 102 to access a user interface or prediction-related communication.

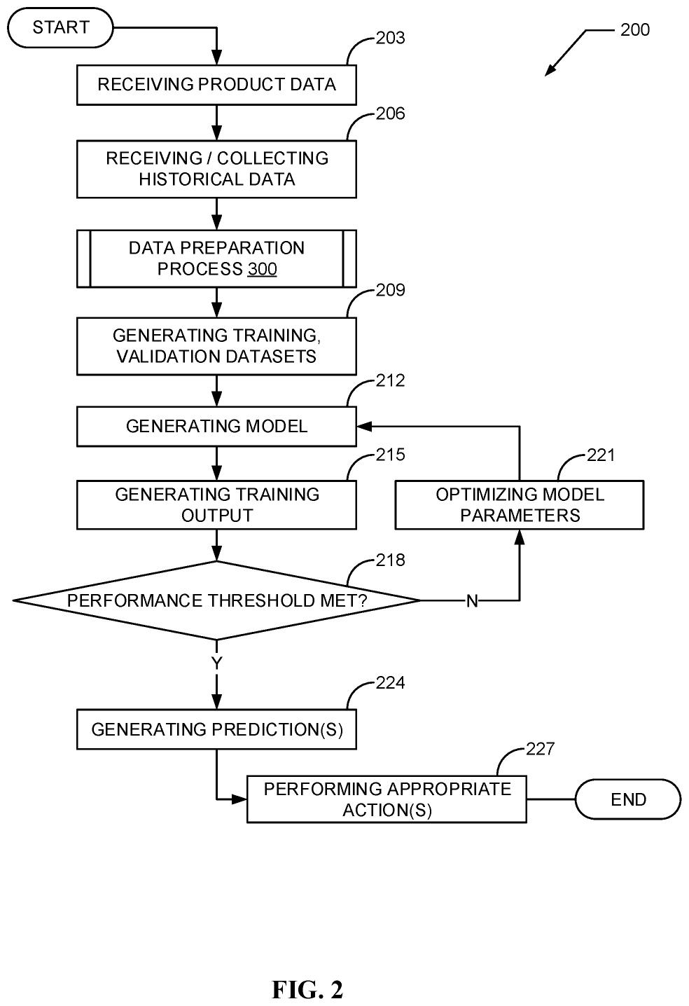

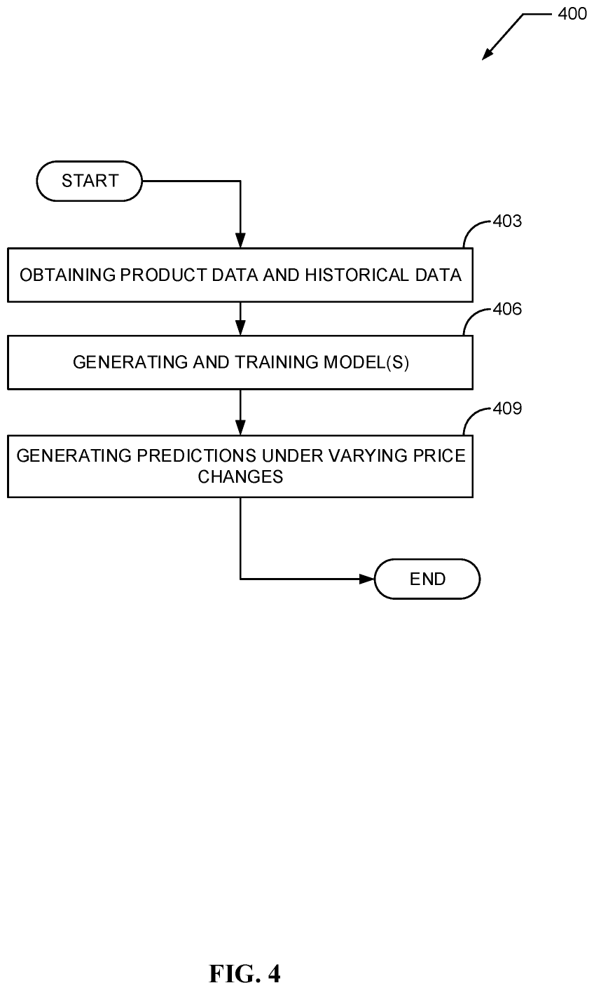

The computing device 102 can include any network-capable electronic device including, but no limited to, personal computers, mobile phones, tablets, Internet of Things (IoT) devices, and external computing systems. The computing device 102 can include, but is not limited to, one or more displays 127, one or more inputs devices 129, and an application 131. The display 127 can include, for example, one or more devices such as liquid crystal display (LCD) displays, gas plasma-based flat panel displays, organic light-emitting diode (OLED) displays, electrophoretic ink (E ink) displays, LCD projectors, or other types of display devices, etc. The input device 129 can include one or more buttons, touch screens including three-dimensional or pressure-based touch screens, camera, finger print scanners, accelerometer, retinal scanner, gyroscope, magnetometer, or other input devices. The application 131 can request, support and/or execute processes described herein, such as, for example, the prediction processes 200, 400 shown in FIGS. 2 and 4, respectively, and described herein. The application 131 can generate user interfaces and cause the computing device 102 to render user interfaces on the display 127. For example, the application 131 generates a user interface including an original appearance of particular data and a second appearance of the particular data following de-identification of one or more data variables 117 therein.

The application 131 can generate and transmit requests to the prediction system 101. The application 131 can request and receive, from the prediction system 101, predictions 125 and various communications related to the same, such as, for example, recommendations for optimizing product attributes based on one or more predictions 125. The application 131 can store requests and request responses in memory of the computing device 102 and/or at a remote computing environment operative to communicate with the computing device 102.

FIG. 2 shows an example prediction process 200 that can be performed by one or more embodiments of the present prediction systems, such as the prediction system 101 shown in FIG. 1 and described herein. The prediction system 101 can perform the prediction process 200 to generate one or more predictions 125 for a product, such as, for example, sales revenue predictions and sales volume predictions, and to identify product attributes, econometric indicators, and psychographic indicators that may be most productive of product success. According to one embodiment, the prediction system 101 performs the process 200 to predict, in an attribute-based approach, sales of new products that lack a sales history. In various embodiments, by the process 200, the prediction system 101 generates and trains a model 119 to predict sales volume for a product that has not entered the market and has no sales history by assessing the product's attributes, calculating the influence each attribute has within a given subcategory, and predicting each attribute's performance based on other products within the subcategory and their corresponding historical performance and sales data. The model 119 can perform various functionality when utilized, implemented, or otherwise executed as part of software or hardware on one or more computing devices, such as, for example, via the prediction system 101. In a particular example, by the process 200, the prediction system 101 predicts one or more product attributes 114 that are most predictive for a particular product (e.g., the particular product being associated with a particular product category, or plurality thereof).

At step 203, the process 200 includes receiving product data 113 associated with one or more products. In some embodiments, receiving the product data 113 includes receiving one or more electronic records related to a product and processing the electronic records to extract and/or generate product data 113. The intake service 103 and/or NLP service 105 can receive, from a computing device 102, a request to generate a prediction 125 for a particular product. The request can include product data 113 and/or identify the particular product such that product data 113 can be obtained by the intake service 103 from computing devices 102, report systems 104, commerce systems 106, and media systems 108. The intake service 103 can automatically request product data from the computing devices 102, the report systems 104, the commerce systems 106, the media systems 108, and/or any particular system distributed across the network 110. For example, the intake service 103 can request product data 113 from the report systems 104 on a weekly, bi-weekly, monthly, daily, or any time interval basis.

At step 206, the process 200 includes receiving or, in some embodiments, retrieving historical data 115. The intake service 103 and/or NLP service 105 can receive historical data 115 from computing devices 102, report systems 104, commerce systems 106, and media systems 108. The intake service 103 can retrieve historical data 115 from the data store 111. According to one embodiment, the retrieved historical data 115 corresponds to, or is otherwise associated with, at least a portion of the product data 113 of step 203.

The process 200 can include performing one or more data preparation processes 300 (FIG. 3) to process the product data 113 and historical data 115 (e.g., or other data elements from which product data 113 or historical data 115 may be extracted or derived, such as electronic records). In various embodiments, the intake service 103 and/or NLP service 105 store the processed product data 113 and historical data 115 at the data store 111.

At step 209, the process 200 includes generating one or more training datasets, and, in some embodiments, one or more validation datasets, based on the historical data 115. Generating the training dataset can include generating a set of variables 117 and known outcomes based on the historical data 115. Non-limiting examples of known outcomes can include historical product performance and sales data (e.g., sales volume, sales revenue, etc.) and product success drivers (e.g., product attributes, econometric indicators, psychographic indicators, etc.). In some embodiments, step 209 includes segregating a training dataset into a secondary training dataset, a validation training dataset, and a testing dataset. According to one embodiment, the dataset of step 209 is generated such that the dataset encompasses a full sales scope for the product for which a prediction 125 is being generated. In least one embodiment, full sales scope refers to all historical data 115 that may be relevant to a product for which the process 200 is performed. According to one embodiment, sales scope refers to a percentage of category revenue that is covered by historical data 115, such as historical point of sale data. At step 209, the intake service 103 may generate the dataset such that the dataset demonstrates a coverage rate above 95 percent of revenue, or any other suitable percentage. According to one embodiment, the initial dataset of step 209 demonstrates a sales scope of 100% (e.g., “full”). In at least one embodiment, from the initial dataset, the intake service 103 generates a first training dataset that includes a sales scope of 70%. According to one embodiment, for fine tuning of the model 119 during training, the intake service 103 generates a second training dataset that includes 15% sales scope and excludes the first dataset. In various embodiments, the intake service 103 generates one or more testing or validation datasets that include a remaining 15% sales scope (e.g., the testing or validation dataset excludes the first and second training datasets). The model service 107 can train a model 119 using the various datasets to perform cross-validation and ensure model stability.

At step 212, the process 200 includes generating a model 119 configured to a) receive, as input, the variables 117 of the training dataset(s) generated at step 209, b) identify one or more products in the training dataset(s) that demonstrate a full training sales scope, a full validation sales scope, and/or a full testing sales scope, c) randomly select a product from the one or more products that were identified, and d) generate a prediction 125 corresponding to the randomly selected product (e.g., a sales volume prediction, sales revenue prediction, or any suitable prediction).

At step 215, the process 200 includes generating training output via executing the model 119 of step 212 on one or more training datasets of step 209. The training output can include one or more predictions 125 and weight values for controlling the contribution of each variable 117 to the prediction 125. In at least one embodiment, the model 119 generates the prediction 125 by creating a forest of decision trees for generating the prediction 125 based on the variables 117 and by applying one or more gradient boosting algorithms to the forest of decision trees.

At step 218, the process 200 includes determining if the current iteration model 119 meets one or more predetermined performance thresholds based on the training output of step 215 (e.g., one or more generated test predictions). The model service 107 can compute one or more performance metrics (e.g., accuracy, error, deviation, precision, etc.) by comparing the training output of step 215 to the known outcomes of the corresponding training dataset. For example, the model service 107 compares a predicted sales volume of 250 units to a known outcome of 375 units. Based on the comparison, the model services 107 determines that the model 119 predicted product sales volume at a 50% level of deviation. In various embodiments, the model service 107 evaluates one or more of model accuracy, R², root mean square deviation, and other metrics by comparing predictions 125 generated via executing the model 119 on training, testing, and/or validation datasets. in response to the predictive model meeting the predetermined performance threshold, the model services 107 can use the predictive model to generate the prediction (e.g., proceed to step 224).

In response to determining that the performance metric of the model 119 fails to meet the predetermined performance threshold, the process 200 can proceed to step 221. In response to determining that the performance metric of the model 119 meets the predetermined performance threshold, the process 200 can proceed to step 224. The model service 107 can perform steps 212-221 in an iterative manner to retest and train multiple model iterations until a model 119 is generated that demonstrates threshold(s)-satisfying levels of performance in one or more performance metrics and/or the predetermined performance threshold. The model service 107 can perform steps 212-221 using multiple training datasets, one or more validation datasets, and one or more testing datasets to ensure the model 119 is robust to varying inputs and is not overfit or underfit to a particular dataset.

At step 221, the process 200 includes optimizing one or more model parameters towards improving performance of the current iteration model 119 (e.g., or a subsequent iteration model 119 generated at step 212). The model service 107 can adjust parameter weight values towards reducing error or deviation in the model 119, or toward increasing the accuracy thereof. The model service 107 can tune the properties 121 of the model 119, such as, for example, hyperparameters including learning rates, number of estimators, number of leaves, and maximum depth. Following step 221, the process 200 can proceed to steps 212-218 in which a subsequent iteration model 119 may be generated, executed on training data, and evaluated for sufficient performance.

At step 224, the process 200 can include generating one or more predictions 125 by executing the trained model 119 on the product data received at step 203 (e.g., or, processed product data from one or more data preparation processes 300). The model service 107 can generate variables 117 based on the product data, such as, for example, product attributes 114 and econometric indicators 116 related to product launch plans (e.g., product launch date, product launch channels, etc.). The model service 107 can execute the model 119 on the variables 117 and generate a prediction 125, such as an estimated sales volume or sales revenue. In some embodiments, the model service 107 analyzes the model 119 to determine one or more variables 117 (e.g., or related product data, such as a particular product attribute 114) that most positively or most negatively contributed to the prediction 125. For example, the model service 107 determines that a summer launch date for a winter coat product is the most negative contributor to a sales revenue prediction for the winter coat product. In another example, the model service 107 determines that a drink product's strawberry flavor is the most positive predictor to a sales volume prediction for the drink product.

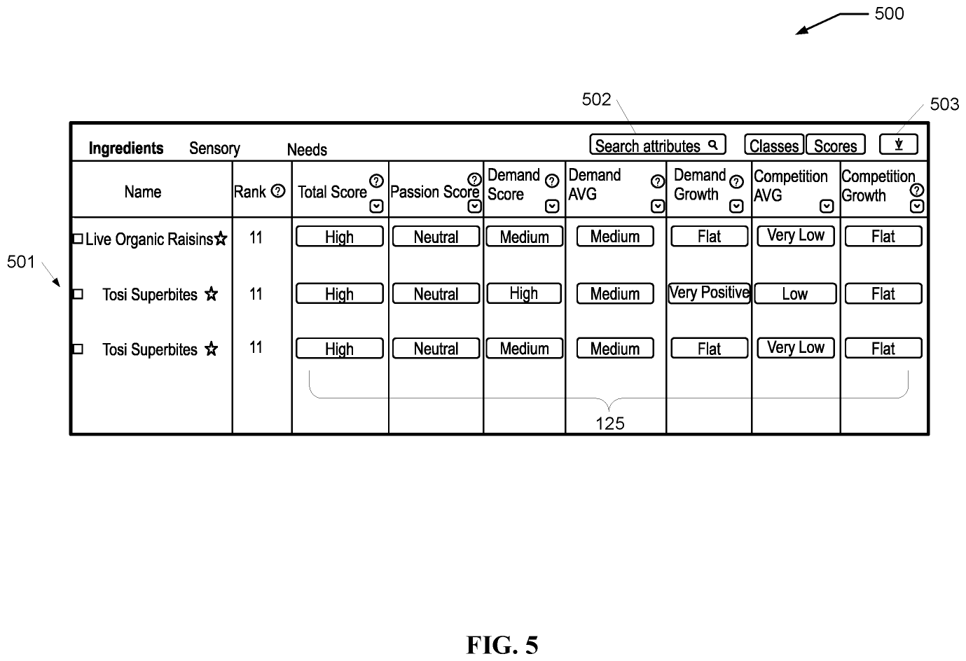

At step 227, the process 200 includes performing one or more appropriate actions, including, but not limited to, transmitting the prediction 125 to one or more computing devices 102, storing the prediction 125 at the data store 111 or a remote storage environment, updating a user interface and/or display to include the prediction 125 (e.g., and additional data, such as highly weighted variables or product data), and modifying one or more aspects of the variables 117 or product data and generating a new prediction 125. In one example, the report service 109 generates a user interface including the prediction 125 and causes the application 131 to render the user interface on the display 127 of the computing device 102. In another example, the report service 109 can generate a recommendation for one or more changes to product attributes 114, econometric indicators 116, or psychographic indicators 118 for improving upon the prediction 125. In this example, the report service 109 may indicate that a change to a product's flavor, color, ingredient, sales channel, or target audience could improve the product's predicted sales volume, sales revenue, or other success marker (e.g., consumer demand, brand exposure, competitiveness, etc.). In at least one embodiment, the report service 109 generates a prediction summary that includes predictions 125 or prediction-derived intelligence for one or more product attributes (see, for example, the prediction summary 500 shown in FIG. 5).

The report service 109 can generate a user interface and/or graphical report for displaying the optimal permutation. The report service 109 can host the user interface at a networking address accessible via a user's computing device and/or a web application. The report service 109 can transmit the graphic report to a user's computing device for rendering on a display thereof. The report service 109 can determine, and report to a user's computing device 102, one or more model inputs (e.g., historical product attributes, econometric indicators, psychographic indicators, or unstructured data elements) that are most positively or negatively predictive for positive or negative sales performance.

In an example scenario, for a planned hiking backpack product, the model service 107 generates and trains a sales prediction model 119 using historical sales data and product data from a plurality of existing hiking backpack products. The model service 107 generates variables 117 based on the historical product data, assigns initial weight values to the input model parameters, and generates a first iteration predictive model 119 that generates a sales prediction 125 based on the variables 117. The model service 107 determines an accuracy level of the first iteration predictive model 119 by comparing the sales prediction to the known outcomes of the historical sales data. The model service 107 trains the predictive model 119 by adjusting one or more weight values, or other properties 121, towards improving the accuracy level of the model, generating additional sales predictions, and performing additional comparisons to the historical sales data. The model service 107 iteratively trains the predictive model 119 until generating a final iteration predictive model 119 that demonstrates a threshold-satisfying accuracy level. Based on parameter weight values in the final iteration prediction model 119, the prediction system 101 determines that product attributes 114 of “weight-offloading,” “waterproof,” and “less than $200” are most positively predictive for positive sales performance in hiking backpack products. The report service 109 generates and transmits to the user's computing device 102 a prediction summary including the most positively predictive product attributes 114.

FIG. 3 shows an example data preparation process 300 that may be performed by an embodiment of the prediction system 101. The process 300 may be performed by the prediction system 101 shown in FIG. 1 and described herein. In a particular example, the intake service 103 and NLP service 105 perform the process 300. In various embodiments, the prediction system 101 performs the process 300 on a product dataset including product data 113 or historical data 115 associated one or more products.

At step 303, the process 300 includes filtering out, from the product dataset, product entries with very rare sales (e.g., product+channel combinations with less than 3 data points). For example, the prediction system 101 can filter out product data 113 product entries with very rare sales.

At step 306, the process 300 includes replacing missing entries (including entries with missing data values) in the product set (e.g., product data 113) with suitable replacement values, such as replacing missing sales values with “0” and replacing missing price values a mean or median value of other price values or a price value of another entry. For example, the prediction system 101 can analyze the product data 113, the historical data 115, and/or the variables 117 to identify missing data entries. Continuing this example, the prediction system 101 can fill the identified missing data entries with a binary value, a mean value of similar data, a mode value of similar data, and/or any other appropriate data point for filling the missing data entries.

At step 309, the process 300 includes replacing outlier entries in the product set. The intake service 103 can identify an outlier data entry within the product dataset by determining that a value thereof fails to meet a predetermined threshold associated with the dataset and/or falls outside a distribution of values associated with the dataset. The predetermined threshold can include, for example, a distance from a mean, median, or mode of the dataset, or a number of standard deviations therefrom. In at least on example, the predetermined data range corresponds to a particular percentile value (e.g., a range between the 25^{th} percentile and the 75^{th} percentile). In another example, the predetermined data range corresponds to a particular number of standard deviations away from a mean of data entries stored and associated with the particular product. The system can replace an outlier data entry with a new entry whose value is a percentile value (e.g., 90th percentile or any other suitable percentile), median, mean, mode, or other metric derived from other data entries associated with the same data type(s).

Sales outliers are defined via statistical techniques, such as, for example, identifying 95^{th} percent, 99^{th} percent, or any suitable percent quartiles within a distribution of a set of product data. In various embodiment, in response to detecting an outlier value in a dataset entry, the intake service 103 can replace the outlier value with an average of values from neighboring entries. In one example, the intake service 103 converts a time series with values [3, 7, 50, 4, 8] to a smoothed time series of [3, 7, 15, 4, 8].

At step 312, the process 300 includes retrieving product attributes 114, in the form of categorical features, from one or more sources of product data 113, such as product descriptions, product advertisements, or product reviews. In some embodiments, step 315 includes generating and adding to the product data 113 additional features based on the product for which predictions are to-be-generated, one or more categories of the product, or business logic with which the product is associated. In some embodiments, the prediction system 101 performs step 312 in response to determining that the product dataset includes an insufficient quantity of product attributes (e.g., by comparing the number of product attributes in the product dataset to one or more thresholds).

At step 315, the process 300 includes encoding the categorical features into the product dataset via mean target encoding. For example, for each categorical feature, the intake service 103 may replace the categorical feature with mean sales within the corresponding category.

At step 318, the process 300 includes encoding binary features in the product set as Boolean values (e.g., 1 and 0) and, in some embodiments, adding Boolean operators (e.g., AND, OR, NOT). For example, the prediction system 101 can encode binary features into the product data 113 as Boolean values and, in some embodiments, adding Boolean operators. For example, the prediction system 101 can generate a string of Boolean operators linking two or more product attributes 114 (e.g., Color AND Shape for a particular product).

At step 321, the process 300 includes generating and encoding date features into the product dataset. For example, from a product description, the NLP service 105 can identify and extract a product release period and product launch date. The intake service 103 can encode the product release period and product launch date as additional entries to the product dataset.

At step 324, the process 300 includes adding additional data to the product dataset, such as, for example, macroeconomic indicators, search trend data, and comment- or review-derived data. For example, the NLP service 105, the model service 107, and/or the intake service 103 can generate, receive, and/or produce additional data to the product data 113. Continuing this example, the intake service 103 can add macroeconomic indicators to the econometric indicators 116 for a particular product indexed in the product data 113.

At step 327, the process 300 includes performing appropriate actions, such as storing the modified product dataset, requesting additional product information (e.g., from the computing device 102, report system 104, commerce system 106, or media system 108), and generating training, validation, or testing datasets based on the modified product dataset. For example, the prediction system 101 can perform appropriate actions, such as storing the modified product dataset into the product data 113, requesting additional product information (e.g., from the computing device 102, report system 104, commerce system 106, or media system 108), and generating training, validation, or testing datasets based on the modified product dataset (e.g., stored in the product data 113).

FIG. 4 shows an example prediction process 400 that can be performed by one or more embodiments of the present prediction system 101, such as the prediction system 101 shown in FIG. 1 and described herein. The prediction system 101 can perform the prediction process 400 to generate one or more predictions 125 for a product, such as, for example, predictions for sales volume based on various product price changes. In various embodiments, by the process 400, the prediction system 101 predicts the change of sales volumes (e.g., units or revenue), based on simulated changes to price of a given product. In one or more embodiments, prediction system 101 identifies historical relationships between price elasticity and forecasted product sales. In at least one embodiment, the prediction system 101 generates one or more models 119 that allows including different pricing scenarios as inputs to a series of different sales forecasts.

At step 403, the process 400 can include obtaining product data 113 for one or more products. The product data 113 can include sales data for a given product, such as unit or revenue sales by product, across a category, by time period (e.g., daily, weekly), by channel (e.g., retailer, physical store, online store, etc.), by location and/or location level (e.g., neighborhood, city, region, state, country, etc.), or one or more combinations thereof. The product data 113 can include price data for a given product, such as price of a product by respective time period, by channel, by location, or one or more combinations thereof. In one or more embodiments, the intake service performs step 403.

At step 406, the process 400 can include generating and training one or more models 119 via the model service 107. In various embodiments, the model 119 generates predictions 125 for estimating sales volume percentage change for each price change by product group (e.g., brand+category or subcategory group). According to one embodiment, the model 119 is configured to perform operations including, but not limited to:
Calculating the percentage change of sales (revenue or units) and price by product; and channel and/or location from two time periods;
Filtering out data outliers using business logic (e.g., percentage change of units sales that exceeds 5000% and price change that exceeds 300%).
Grouping subsets of the product data 113 into data groups by brand/subcategory or other dimensions; and
For each data group, fitting a, b and c coefficients for function y=a*exp(−b*x)+c, where x is a percentage change of price from one period to another, and y is a percentage change of sales (units or revenue) for respective periods.

In one or more embodiments, the model 119 is configured to visualize the product data 113 by providing a function fitted for each data group. The model service 107 may use the function(s) to evaluate model accuracy and/or other performance factors. The model service 107 can train, validate, and test the model 119 using one or more datasets derived from historical data 115. The model service 107 can iteratively adjust one or more properties 121 of the model 119 to generate a model iteration that demonstrates threshold-satisfying performance.

At step 409, the process 400 can include generating one or more predictions 125 via the model 119. The model service 107 can execute the model 119 on the product data 113 of step 403 under varying pricing conditions and, thereby, generate predictions 125 including product volume changes under each pricing condition.

FIG. 5 shows an example prediction summary 500 that may be generated by the report service 109 (FIG. 1). The prediction summary 500 can include one or more predictions 125, such as, for example, predicted importance scores for a plurality of attributes across a plurality of metrics including, but not limited to, total score, passion score, demand score, demand average (AVG), demand growth, competition average (AVG), and competition growth. The report service 109 can color code the one or more predictions 125 in terms of severity. For example, the report service 109 can generate all “High” predictions 125 with the color red, all “Medium” predictions 125 with the color orange, all “Neutral” predictions 125 with no color, all “Low” predictions 125 with a light green, and all “Very Low” predictions 125 with a dark green color. The prediction summary can include name list 501 listing all the names of the particular products.

Though not illustrated, the prediction summary 500 can include various reports generated by the report service 109. For example, the report service 109 can render the prediction summary 500 with various tabs describing various predictions generated by the prediction system 101. In one example, a tab can include an quarterly report for predicted sales of a particular product. In another example, the report service 109 can render the prediction summary 500 with an export feature (e.g., excel export, text file export, .CSV exports).

The prediction summary 500 can include a search function 502 and a sort function 503. When displayed on the display 127 of the computing device 102, the application 131 can receive a search request from the input device 129 through the search function 502. The search function can search any particular prediction 125, name listed in the name list 501, and/or any particular attribute associated with the prediction summary. When displayed on the display 127 of the computing device 102, the application 131 can receive a sort request from the input device 129 through the sort function 503. The sort function 503 can facilitate sorting the prediction summary 500 in any particular order.

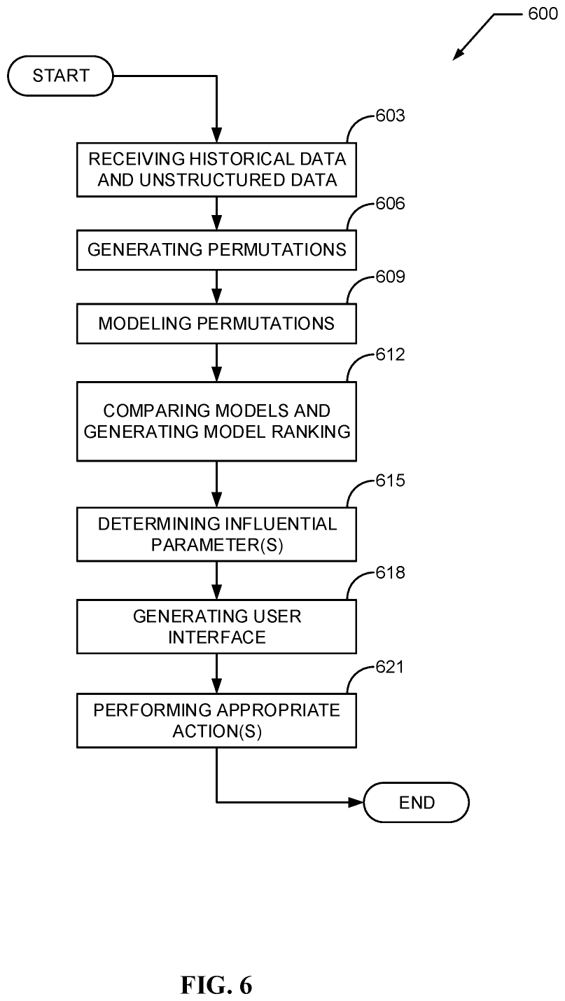

Referring now to FIG. 6, illustrated is a process 600, according to one embodiment of the present disclosure. The process 600 can correspond with a technique for processing historical data 115 and unstructured data, generated a model with the historical data 115 and unstructured data, applying the model to determine the influential parameter(s), and generate the prediction summary 500 to include the information deduced through the process 600. The prediction system 101 can perform the process 600 and generate the prediction summary 500 with the information gathered through the process 600.

At box 603, the process 600 can include receiving historical data 115 and unstructured data. The prediction system 101 can receive historical data 115 and/or the unstructured data from any particular source distributed across the networked environment 100. For example, the prediction system 101 can receive historical data 115 and/or the unstructured data from the report systems 104, the commerce systems 106, the media systems 108, or a combination thereof. The intake service 103 can extract the unstructured data from the product data 113, the historical data 115, and/or the variables 117.

At box 606, the process 600 can include generating one or more permutations 123. The model service 107, the intake service 103, and/or any other particular service of the prediction system 101 can generate permutations 123. The model service 107 can generate permutations 123 by aggregating product data 113 and historical data 115 into associated data pools. For example, the model service 107 can aggregate historical sales data for a particular video game with the know genre (e.g., role playing game (RPG)) stored in the product attributes 114 of the particular video game. In another example, the model service 107 can generate a particular permutation 123 that include an association (e.g., a Boolean association using Boolean operators) between the historical sales data for all games that include the product attribute 114 of RPG as the genre.

At box 609, the process 600 can include modeling the one or more permutations 123. The model service 107 can model the one or more permutations 123. The model service 107 and/or the NLP service 105 can employ the one or more machine learning models, natural language processing models, and/or any particular model to predict the correlation between the various aggregated features of the permutations 123. For example, the NLP service 105 can extract various product attributes 114 from the unstructured data (e.g., a product review on a third-party website) using key word extraction techniques. In another example, the model service 107 can employ a regression algorithm (e.g., decision trees) to determine the correlation of historical sale data with the genre of a particular video game. The model service 107 can generate a training data set, a testing data set, and a validation data set from the permutations 123. The model service 107 can apply models to the testing data set and the training data set to tune the model, similarly in the process 200 and 300 discussed herein. The model service 107 can employ K-Fold Cross-Validation and/or any particular validation technique to validate the one or more generated models based on the permutations 123.

At box 612, the process 600 can include comparing models and generating a model ranking. The prediction system 101 can compare models generated by the model service 107 and rank the models based on a variety of factors. For example, the prediction system 101 can rank the models based on the K-Fold Cross-Validation outputs and/or any validation outputs generated for the respective models. In another example, the prediction system 101 can rank the models based on various efficiency rates (e.g., time to complete, number of iterations, power efficiency for the prediction system 101) and efficiency to output quality ratios. Based on the ranking of the models, the prediction system 101 can select a model for processing the one or more permutations 123 and/or future data received from devices across the network 110.

At box 615, the process 600 can include determining influential parameter(s) of the one or more models. The prediction system 101 can determine influential parameters of the one or more models. For example, the prediction system 101 can track the varying validation scores of the one or more models during the training and testing phase of the models. Continuing this example, the prediction system 101 can analyze the changing hyperparameters, changing data, and/or any other variations from one iteration to the next that had a large influence on the validation outcome of the one or more models.

At box 618, the process 600 can include generating a user interface. The prediction system 101 can generate a user interface for rendering on the display 127 of the computing device 102. The user interface can be substantially similar to the prediction summary 500. The prediction system 101 can include the model ranking of the one or more models in the user interface. For example, the prediction system 101 can render a model ranking that ranks the models on their ability to predict a particular products future sales based on the size of the product. In another example, the prediction system 101 can render a model ranking that ranks the models on their time efficiency versus their output correctness. In various embodiments, the prediction system 101 can calculate and render a comparison value between the ranked models that quantifies the increased abilities of each subsequently ranked model (e.g., the first ranked model is 42% more efficient than the second ranked model).

At box 621, the process 600 includes performing appropriate actions, such as storing the modified product dataset, requesting additional product information (e.g., from the computing device 102, report system 104, commerce system 106, or media system 108), and generating training, validation, or testing datasets based on the modified product dataset. The prediction system can perform appropriate actions, such as storing the modified product dataset, requesting additional product information (e.g., from the computing device 102, report system 104, commerce system 106, or media system 108), and generating training, validation, or testing datasets based on the modified product dataset.

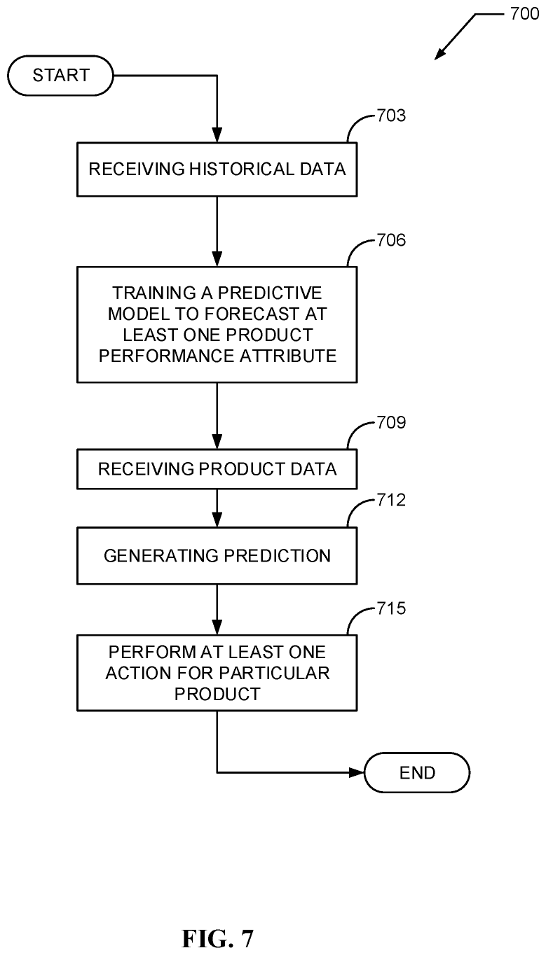

Referring now to FIG. 7, illustrated is a flowchart of a process 700, according to one embodiment of the present disclosure. The process 700 can illustrate a technique for generating predictions for one or more products based on historical data 115 and other product data 113. The prediction system 101 can perform the process 700 to generate one or more predictions associated with the particular product analyzed by the prediction system 101.

At box 703, the process 700 can include receiving historical data 115 for a plurality of historical products in a plurality of markets. The prediction system 101 can receive historical data 115 for a plurality of historical products in a plurality of markets. The prediction system 101 can receive historical data 115 from the report system 104, the commerce system 106, the media system 108, and/or any particular service distributed across the network 110. The prediction system 101 can receive the historical data 115 and store the historical data 115 in the data store 111. The prediction system 101 can receive historical data 115 associated with one or more historical products. For example, the prediction system 101 can receive from a video game company the last five years of economic variables associated with the sales, production, and distribution of all video games made available by the video game company. In another example, the prediction system 101 can receive historic sales data for one or more video game consoles sold by a video game retailer.

At box 706, the process 700 can include training a predictive model from the models 119 to forecast at least one product performance attribute based on the historical data 115. The prediction system 101 can train the predictive model from the models 119 to forecast at least one product performance attribute based on the historical data 115. For example, the model service 107 and/or the NLP service 105 can perform the process 300 to prepare the historical data 115 for processing through the predictive model. The model service 107 can generate the training dataset, the testing dataset, and the validation dataset for processing through the predictive model. For example, the training dataset can include 60% of a first subset of data from the historical data 115. Continuing this example, the testing data set can include 20% of a second subset of data from the historical data 115, where the second subset of data is distinct from the first subset of data. Further continuing this example, the validation data set can include 20% of a third subset of data from the historical data 115, where the third subset of data is distinct from the first subset of data and the second subset of data.

The prediction system 101 can select the predictive model based on the product performance attribute. The product performance attribute can be defined as one or more metrics used to evaluate the performance of the particular product based on the product data 113 and/or the historical data 115. For example, the prediction system 101 can employ the historical data 115 to generate a correlation between the color of the particular object and its initial starting retail price. The product performance attribute can be substantially similar to the product attribute 114. The prediction system 101 can choose from any particular model 119 to generate a forecast model that draws a correlation between the historical data 115 and the product performance attribute. The prediction system 101 can employ the process 200 to train, test, and validate the predictive model on its ability to forecast one or more product performance attributes based on the historical data 115.

At box 709, the process 700 can include receiving product data 113 associated with the particular product. The prediction system 101 can receive product data 113 associated with the particular product. For example, the prediction system can receive product data 113 from the commerce system 106 and/or any particular system distributed across the network 110. The prediction system 101 can organize the product data 113 received from various sources distributed on the network 110 by storing the product data into the product attributes 114, the econometric indicators, and/or the psychographic indicators 118. The intake service 103 can extract the product data 113 from various types of data. For example, the intake service 103 can extract sales data associated with the particular product from the 10k report of a publicly traded company that manufactures the particular product.

At box 712, the process 700 can include generating a prediction for the particular product of the at least one product performance attribute by applying the predictive model. The prediction system 101 can generate a prediction for the particular product of the at least one product performance attribute by applying the predictive model. For example, the model service 107 can apply the product data 113 through the predictive model generated based on the historical data 115. In another example, the model service 107 can generate various correlations between the product data 113 and the one or more product performance attributes. The model service 107, can for example, employ a first predictive model that correlates the likelihood someone will purchase the particular item based on the location in which the particular product is placed in a physical store. In another example, the model service 107 can employ a second predictive model that uses the psychographic indicators 118 to predict the likelihood that the subsequent generation of the particular item will have greater sales than the previous generation. In yet another example, the model service 107 can employ a third predictive model that analyzes the econometric indicators 116 associated with the product data 113 of the particular product to determine the sale potential in dollars for the particular product during a recession.

At box 715, the process 700 can include performing at least one action for the particular product based on the prediction of the at least one product performance attribute. The prediction system 101 can perform at least one action for the particular product based on the prediction of the at least one product performance attribute. In prediction system 101 can generate a report based on the prediction of the at least one product performance attribute. The prediction system 101 can render the report based on the prediction of the at least one product performance attribute on the display 127 of the computing device 102. The report can include econometric predictions on the predicted success for the particular product. The report can include, for example, quarterly performance scores (e.g., sales predictions, average hold time for retailers, likelihood of selling out, likelihood of incurring overstock), ranking of most important product performance attributes that impact the sales of the particular product, and/or any other information generated by the prediction system 101 based on the product data 113 and the product performance attribute. The prediction system 101 can generate a strategy report that outlines one or more actions based on the predictions based on the product performance attribute and the product data 113. For example, the prediction system 101 can generate the strategy report to recommend stocking amounts and stocking consistency to ensure the particular product does not sell out at the particular retailer. The prediction system 101 can identify at least one product with sales falling below a predefined threshold from the plurality of particular products. For example, The prediction system 101 can process product data 113 for 10 prototypes of the particular product. Continuing this example, the prediction system 101 can identify at least one of the prototypes with predicted sales below the predefined threshold (e.g., 70% stock sales in the first 6 months).

The prediction system 101 can modify at least one aspect of the product data 113 for the particular product based on the prediction of the at least one product performance attribute. The prediction system 101 can modify the econometric indicators 116 and/or the psychographic indicators 118 associated with the particular product based on the prediction of the at least one product performance attribute. For example, The prediction system 101 can reduce the weight of econometric indicators 116 based on the model service 107 predicting that the particular product likely has a high resilience to recessions. In another example, the prediction system 101 can increase the weight of particular key words found in online review and stored in the psychographic indicators 118 that are predicted to negatively affect the sales of the particular product.

The prediction system 101 can generate a new prediction for the particular product based on the modified at least one aspect of the product data 113. On modifying at least one aspect of the product data 113, the prediction system 101 can re-evaluate the particular model against the updated product data 113. For example, the model service 107 can re-evaluate the particular model to determine the likelihood the particular product will sell out within the first 6 months based on the on the updated product data.

The prediction system 101 generate a plurality of different predictions for the particular product of the at least one product performance attribute by applying the predictive model to a plurality of different pricing values. In various embodiments, the pricing values can be defined as present retail prices for the particular product. The prediction system 101 can iteratively test how different prices affect the outcome of various models 119 for the particular product. For example, the model service 107 can evaluate the predictive model using 100 different price points for the particular product. Continuing this example, the model service 107 can rank the plurality of different predictions based on the price point that will yield the most sales. Further continuing this example, the prediction system 101 can determine one of the plurality of different pricing values corresponding to a highest ranked one of the plurality of different predictions. Once selected, the prediction system 101 can report the price point that provided the best prediction and outcome for the particular product.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such non-transitory computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, example screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are example and other mechanisms of establishing communications over wide area networks or the Internet may be used.

Clause 1. A system, comprising: a data store; and at least one computing device in communication with the data store, the at least one computing device being configured to: receive historical data for a plurality of historical products in a plurality of markets; train a predictive model to forecast at least one product performance attribute based on the historical data; receive product data associated with a particular product; generate a prediction for the particular product of the at least one product performance attribute by applying the predictive model; and perform at least one action for the particular product based on the prediction of the at least one product performance attribute.

Clause 2. The system of clause 1 or any other clause or aspect herein, wherein the at least one action comprises modifying at least one aspect of the product data for the particular product based on the prediction of the at least one product performance attribute.

Clause 3. The system of clause 2 or any other clause or aspect herein, wherein the at least one computing device is further configured to generate a new prediction for the particular product based on the modified at least one aspect of the product data.

Clause 4. The system of clause 1 or any other clause or aspect herein, wherein the at least one computing device is further configured to train the predictive model to forecast the at least one product performance attribute by: generating a training data set and a validation data set based on the historical data; and generating the predictive model configured to receive variables of the training data set and generate test predictions corresponding to products in the training data set.

Clause 5. The system of clause 4 or any other clause or aspect herein, wherein the at least one computing device is further configured to: determine whether the predictive model meets a predetermined performance threshold based on the generated test predictions; and in response to the predictive model meeting the predetermined performance threshold, use the predictive model to generate the prediction.

Clause 6. The system of clause 4 or any other clause or aspect herein, wherein the at least one computing device is further configured to: determine whether the predictive model meets a predetermined performance threshold based on the generated test predictions; and in response to the predictive model failing to meet the predetermined performance threshold, iteratively modify at least one model parameter and retesting the predictive model to determine if a current iteration version of the predictive model meets the predetermined performance threshold.

Clause 7. A method, comprising: receiving, via one of one or more computing devices, historical data for a plurality of historical products in a plurality of markets; training, via one of the one or more computing devices, a predictive model to forecast at least one product performance attribute based on the historical data; receiving, via one of the one or more computing devices, product data associated with a plurality of particular products; generating, via one of the one or more computing devices, a respective prediction for each of the plurality of particular products for the at least one product performance attribute by applying the predictive model; and performing, via one of the one or more computing devices, at least one respective action for individual ones of the plurality of particular products based on the respective prediction of the at least one product performance attribute.

Clause 8. The method of clause 7 or any other clause or aspect herein, further comprising generating, via one of the one or more computing devices, a predictive summary comprising the respective prediction for each of the plurality of particular products.

Clause 9. The method of clause 7 or any other clause or aspect herein, further comprising filtering, via one of the one or more computing devices, at least one product with sales falling below a predefined threshold from the plurality of particular products.

Clause 10. The method of clause 7 or any other clause or aspect herein, further comprising: analyzing, via one of the one or more computing devices, the product data associated with the plurality of particular products to identify missing data values; and replacing, via one of the one or more computing devices, the missing data values with replacement values calculated from other data in the product data.

Clause 11. The method of clause 7 or any other clause or aspect herein, further comprising: analyzing, via one of the one or more computing devices, the product data associated with the plurality of particular products to identify at least one outlier data value that fall outside of a predetermined data range; and replacing, via one of the one or more computing devices, the at least one outlier data value with replacement values corresponding to a percentile for other data entries of a same type.

Clause 12. The method of clause 11 or any other clause or aspect herein, wherein the predetermined data range corresponds to a particular percentile value.

Clause 13. The method of clause 11 or any other clause or aspect herein, wherein the predetermined data range corresponds to a particular number of standard deviations away from a mean of data entries.

Clause 14. A non-transitory computer-readable medium embodying a program that, when executed by at least one computing device, causes the at least one computing device to: receive historical data for a plurality of historical products in a plurality of markets; train a predictive model to forecast at least one product performance attribute based on the historical data; receive product data associated with a particular product; generate a prediction for the particular product of the at least one product performance attribute by applying the predictive model; and perform at least one action for the particular product based on the prediction of the at least one product performance attribute.

Clause 15. The non-transitory computer-readable medium of clause 14 or any other clause or aspect herein, wherein the at least one action comprises generating a recommendation to modify at least one aspect of the product data for the particular product.

Clause 16. The non-transitory computer-readable medium of clause 14 or any other clause or aspect herein, wherein the program further causes the at least one computing device to: generate a plurality of different predictions for the particular product of the at least one product performance attribute by applying the predictive model to a plurality of different pricing values; ranking the plurality of different predictions; and determine one of the plurality of different pricing values corresponding to a highest ranked one of the plurality of different predictions.

Clause 17. The non-transitory computer-readable medium of clause 14 or any other clause or aspect herein, wherein the program further causes the at least one computing device to generate a predictive summary comprising the prediction for the particular product.

Clause 18. The non-transitory computer-readable medium of clause 14 or any other clause or aspect herein, wherein the program further causes the at least one computing device to train predictive model to forecast the at least one product performance attribute by: generating a training data set and a validation data set based on the historical data; and generating the predictive model configured to receive variables of the training data set and generate test predictions corresponding to products in the training data set.

Clause 19. The non-transitory computer-readable medium of clause 18 or any other clause or aspect herein, wherein the program further causes the at least one computing device to: determine whether the predictive model meets a predetermined performance threshold based on the generated test predictions; and in response to the predictive model meeting the predetermined performance threshold, use the predictive model to generate the prediction.

Clause 20. The non-transitory computer-readable medium of clause 14 or any other clause or aspect herein, wherein the predictive model comprises at least one of: a machine learning model or an artificial intelligence model.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the example embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the example embodiments described therein.

What is claimed is:

1. A system, comprising:
a data store; and
at least one computing device in communication with the data store, the at least one computing device being configured to:
receive historical data for a plurality of historical products in a plurality of markets;
train a predictive model to forecast at least one product performance attribute based on the historical data;
receive product data associated with a particular product;
generate a prediction for the particular product of the at least one product performance attribute based on the predictive model; and
perform at least one action based on the prediction of the at least one product performance attribute.

2. The system of claim 1, wherein the at least one action comprises modifying at least one aspect of the product data for the particular product based on the prediction of the at least one product performance attribute.

3. The system of claim 2, wherein the at least one computing device is further configured to generate a new prediction for the particular product based on the modified at least one aspect of the product data.

4. The system of claim 1, wherein the at least one computing device is further configured to train the predictive model to forecast the at least one product performance attribute by:
generating a training data set and a validation data set based on the historical data; and
generating the predictive model configured to receive variables of the training data set and generate test predictions corresponding to products in the training data set.

5. The system of claim 4, wherein the at least one computing device is further configured to:
determine whether the predictive model meets a predetermined performance threshold based on the generated test predictions; and
in response to the predictive model meeting the predetermined performance threshold, use the predictive model to generate the prediction.

6. The system of claim 4, wherein the at least one computing device is further configured to:
determine whether the predictive model meets a predetermined performance threshold based on the generated test predictions; and
in response to the predictive model failing to meet the predetermined performance threshold, iteratively modify at least one model parameter and retesting the predictive model to determine if a current iteration version of the predictive model meets the predetermined performance threshold.

7. A method, comprising:
receiving, via one of one or more computing devices, historical data for a plurality of historical products in a plurality of markets;
training, via one of the one or more computing devices, a predictive model to forecast at least one product performance attribute based on the historical data;
receiving, via one of the one or more computing devices, product data associated with a plurality of particular products;
generating, via one of the one or more computing devices, a respective prediction for each of the plurality of particular products for the at least one product performance attribute based on the predictive model; and
performing, via one of the one or more computing devices, at least one action based on the respective prediction for each of the plurality of particular products of the at least one product performance attribute.

8. The method of claim 7, further comprising generating, via one of the one or more computing devices, a predictive summary comprising the respective prediction for each of the plurality of particular products.

9. The method of claim 7, further comprising filtering, via one of the one or more computing devices, at least one product with sales falling below a predefined threshold from the plurality of particular products.

10. The method of claim 7, further comprising:
analyzing, via one of the one or more computing devices, the product data associated with the plurality of particular products to identify missing data values; and
replacing, via one of the one or more computing devices, the missing data values with replacement values calculated from other data in the product data.

11. The method of claim 7, further comprising:
analyzing, via one of the one or more computing devices, the product data associated with the plurality of particular products to identify at least one outlier data value that fall outside of a predetermined data range; and
replacing, via one of the one or more computing devices, the at least one outlier data value with replacement values corresponding to a percentile for other data entries of a same type.

12. The method of claim 11, wherein the predetermined data range corresponds to a particular percentile value.

13. The method of claim 11, wherein the predetermined data range corresponds to a particular number of standard deviations away from a mean of data entries.

14. A non-transitory computer-readable medium embodying a program that, when executed by at least one computing device, causes the at least one computing device to:
receive historical data for a plurality of historical products in a plurality of markets;
train a predictive model to forecast at least one product performance attribute based on the historical data;
receive product data associated with a particular product;
generate a prediction for the particular product of the at least one product performance attribute based on the predictive model; and
perform at least one action based on the prediction of the at least one product performance attribute.

15. The non-transitory computer-readable medium of claim 14, wherein the at least one action comprises generating a recommendation to modify at least one aspect of the product data for the particular product.

16. The non-transitory computer-readable medium of claim 14, wherein the program further causes the at least one computing device to:
generate a plurality of different predictions for the particular product of the at least one product performance attribute by applying the predictive model to a plurality of different pricing values;
ranking the plurality of different predictions; and
determine one of the plurality of different pricing values corresponding to a highest ranked one of the plurality of different predictions.

17. The non-transitory computer-readable medium of claim 14, wherein the program further causes the at least one computing device to generate a predictive summary comprising the prediction for the particular product.

18. The non-transitory computer-readable medium of claim 14, wherein the program further causes the at least one computing device to train predictive model to forecast the at least one product performance attribute by:
generating a training data set and a validation data set based on the historical data; and
generating the predictive model configured to receive variables of the training data set and generate test predictions corresponding to products in the training data set.

19. The non-transitory computer-readable medium of claim 18, wherein the program further causes the at least one computing device to:
determine whether the predictive model meets a predetermined performance threshold based on the generated test predictions; and
in response to the predictive model meeting the predetermined performance threshold, use the predictive model to generate the prediction.

20. The non-transitory computer-readable medium of claim 14, wherein the predictive model comprises at least one of: a machine learning model or an artificial intelligence model.
